(19) United States
(12) Patent Application Publication
(10) Pub. No.: US 2013/0261251 A1
(43) Pub. Date: Oct. 3, 2013

(54) MONOMER-GRAFTED ALKYD ESTER RESINS

(71) Applicants: Dean C. Webster, Fargo, ND (US); Thomas J. Nelson, Fargo, ND (US)

(72) Inventors: Dean C. Webster, Fargo, ND (US); Thomas J. Nelson, Fargo, ND (US)

(73) Assignee: NDSU RESEARCH FOUNDATION, Fargo, ND (US)

(21) Appl. No.: 13/704,034

(22) PCT Filed: Jun. 16, 2011
(86) PCT No.: PCT/US11/40717

§ 371 Date: Mar. 7, 2013

Related U.S. Application Data
(60) Provisional application No. 61/355,497, filed on Jun. 16, 2010.

(51) Int. Cl. C09D 147/00

(52) U.S. Cl. CPC C09D 147/00
USPC 524/549

(57) ABSTRACT

Alkyd resin compositions which comprise the monomer-grafting polymerization of a) an alkyd, which is an ester of a polyol having 4 or more hydroxyl groups and an unsaturated fatty acid, and b) an unsaturated monomer having a carbon-carbon double bond are disclosed. The alkyd may be a partially esterified polyol. Coating compositions of containing the alkyd resin compositions of the invention are also disclosed.

### CROSS-REFERENCE TO RELATED APPLICATIONS

This application claims priority to PCT International Application No. PCT/US2011/040717, filed Jun. 16, 2011; which claims priority to U.S. Application 61/355,497, filed Jun. 16, 2010, which is incorporated herein by reference.

### STATEMENT OF GOVERNMENT RIGHTS

This invention was funded at least in part by funds from the U.S. Government (Grant No. 2007-38202-18597). The U.S. Government has certain rights in this invention.

### FIELD OF THE INVENTION

The invention relates to alkyd resin compositions containing alkyd resins grafted with unsaturated monomers. The alkyd resins of the invention are formed from polyol esters of fatty acids which are grafted with unsaturated monomers. The alkyd resin compositions of the invention are useful in coating compositions.

### BACKGROUND OF THE INVENTION

The utilization of plant or vegetable oils and other renewable resources for commercial applications is gaining momentum as a result of the emerging disadvantages originating from the use of petrochemicals (e.g., higher oil prices, waste disposal, and climate change). Meier, M. A. R. et al., Chem. Soc. Rev., 2007, 36, 1788-1802. Historically, drying oils have been used as the principal binder system in coatings. However, their use was diminished with the advent of more modern coating technologies, which had superior coatings properties, such as acrylics and polyurethanes. Wicks Z. W.; Jones, F. N.; Pappas S. P.; Wicks D. A. Alkyd Resins. Organic Coatings: Science and Technology, 3^{rd} ed.; Wiley-Interscience: Hoboken, N.J., 2007; p 306. However, as the coatings industry seeks to decrease its dependence on coatings made with petrochemicals, resurgence in the use of natural oils as eco-friendly starting materials is imminent. Güner F. S. et al., Prog. Polym. Sci., 2006, 31, 633-670.

Vegetable oils are derived from the seeds of various plants and are chemically triglycerides of fatty acids. That is, vegetable oils consist of three moles of fatty acids esterified with one mole of glycerol. As shown below in Formula I, fatty acids are linear carboxylic acids having 4 to 28 carbons and may be saturated or ethylenically unsaturated.

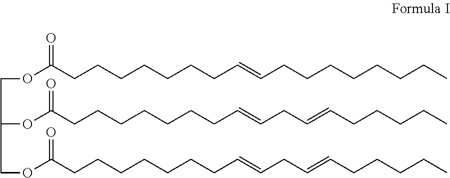 [SMILES: CCCCC/C=C/C/C=C/CCCCCCCC(=O)OCC(COC(=O)CCCCCCC/C=C/CCCCCCCC)OC(=O)CCCCCCC/C=C/C/C=C/CCCCC]

Different plants produce oils having differing compositions in the fatty acid portion of the oil. Naturally-occurring vegetable oils are by definition mixtures of compounds, as are the fatty acids comprising them. They are usually either defined by their source (soybean, linseed) or by their fatty acid composition. A primary variable that differentiates one vegetable oil from another is the number of double bonds in the fatty acid; however, additional functional groups can be present such as hydroxyl groups in castor oil and epoxide groups in vernonia oil. Table 1 below identifies the typical fatty acid composition for some commonly occurring vegetable oils.

TABLE 1

| | Fatty Acid | Unsaturation | Coconut | Corn | Soybean | Safflower | Sunflower | Linseed | Castor | Tall Oil FA | Tung |
|---|---|---|---|---|---|---|---|---|---|---|---|
| C₁₂ | Lauric | 0 | 44 | | | | | | | | |
| C₁₄ | Myristic | 0 | 18 | | | | | | | | |
| C₁₆ | Palmitic | 0 | 11 | 13 | 11 | 8 | 11 | 6 | 2 | 5 | 4 |
| C₁₈ | Stearic | 0 | 6 | 4 | 4 | 3 | 6 | 4 | 1 | 3 | 1 |
| | Oleic | 1 | 7 | 29 | 25 | 13 | 29 | 22 | 7 | 46 | 8 |
| | Ricinoleic | 1 | | | | | | | 87 | | |
| | Linoleic | 2 | 2 | 54 | 51 | 75 | 52 | 16 | 3 | 41 | 4 |
| | Linolenic | 3 | | | 9 | 1 | 2 | 52 | | 3 | 3 |
| | Eleaosteric | 3 | | | | | | | | | 80 |
| Iodine | | | 7.5-10.5 | 103-128 | 120-141 | 140-150 | 125-136 | 155-205 | 81-91 | 165-170 | 160-175 |
| Value | | | | | | | | | | | |

Vegetable oils have been used extensively as binder systems in paints and coatings for centuries. Drying oils, such as linseed oil, have been used as a component of paint binders since drying oils can be converted into a tack free film upon reaction with atmospheric oxygen in a process called autoxidation. Vegetable oils have also been used in the synthesis of alkyd resins by combining the fatty acids in the oils with other monomers to form a fatty acid containing polyester resin. Vegetable oils also have several advantages of being renewable, biodegradable and hence have less impact on the environment. Vegetable oils can impart desirable flexibility and toughness to the otherwise brittle cycloaliphatic epoxide system. Wan Rosli, et al., Eur. Polym. J. 2003, 39, 593.

Since drying oils tend to form soft films with little solvent resistance, modifications are commonly performed in order to enhance the film properties. A classical method to modify oils in order to enhance film properties has been explored by reacting an oxidizing oil or alkyd resin with vinyl monomers in a free radical copolymerization. Güner F. S. et al., Prog. Polym. Sci., 2006, 31, 633-670; Bhow N. R.; Payne H. F., Ind. Eng. Chem., 1950, 42 (4), 700-7034. Due to its low cost and high T_{g}, styrene is the most common choice, but any vinyl monomer can be used such as methyl methacrylate. Güner F. S. et al., Prog. Polym. Sci., 2006, 31, 633-670. If styrene is used, the resulting modified alkyd is termed styrenated. The main disadvantage of this process results from the fact that the oxidizing alkyd needs to be initially diluted with a solvent prior to the styrenation process. Furthermore, upon reactions with vinyl monomers, additional solvent is often required in order to obtain a suitable application viscosity, which results in a resin having a high volatile organic content (VOC).

Sucrose, β-D-fructofuranosyl-α-D-glucopyranoside, is a disaccharide having eight hydroxyl groups. The combination of sucrose and vegetable oil fatty acids to yield sucrose esters of fatty acids (SEFA) as coating vehicles was first explored in the 1960s. Bobalek, et al., Official Digest, 1961, 453; Walsh, et al., Div. Org. Coatings Plastic Chem., 1961, 21, 125. However, in these early studies, the maximum degree of substitution (DS) was limited to about 7 of the available 8 hydroxyl groups. The resins do not appear to have been commercialized at that time. In the early 2000s, Proctor & Gamble (P&G) Chemicals developed an efficient process for industrially manufacturing SEFAs commercially under the brand name SEFOSE with a high DS of at least 7.7 (representing a mixture of sucrose hexa, hepta, and octaesters, with a minimum of 70% by weight octaester) (U.S. Pat. Nos. 6,995,232; 6,620,952; and 6,887,947), and introduced them with a focus on marketing to the lubricant and paint industries. Due to their low viscosities (300-400 mPa·s), SEFOSE sucrose esters can be used as binders and reactive diluents for air-drying high solids coatings. Formula II displays the possible molecular structure of a sucrose ester with full substitution. Procter and Gamble has reported a process to prepare highly substituted vegetable oil esters of sucrose using transesterification of sucrose with the methyl esters of sucrose. U.S. Pat. No. 6,995,232.

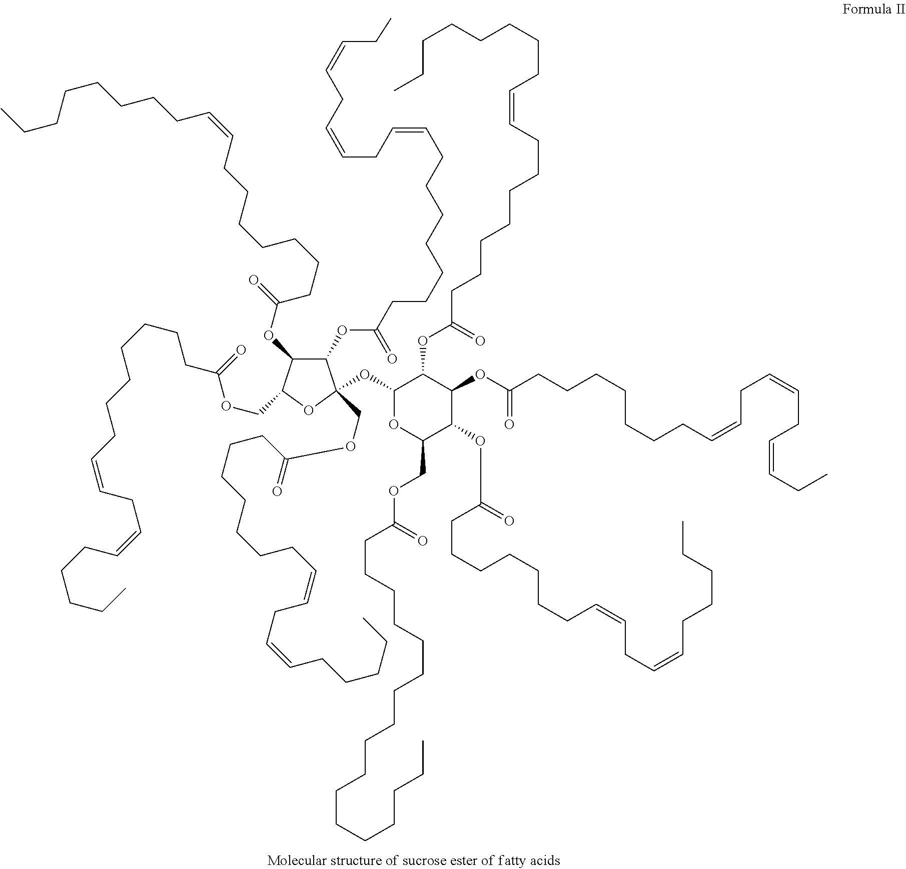 [SMILES: CC/C=C\C/C=C\C/C=C\CCCCCCCC(=O)O[C@@H]1[C@@H](OC(=O)CCCCCCC/C=C\CCCCCCCC)[C@@H](O[C@]2(COC(=O)CCCCCCC/C=C\C/C=C\CCCCC)O[C@H](COC(=O)CCCCCCC/C=C\C/C=C\CCCCC)[C@@H](OC(=O)CCCCCCC/C=C\CCCCCCCC)[C@@H]2OC(=O)CCCCCCC/C=C\C/C=C\C/C=C\CC)O[C@H](COC(=O)CCCCCCCCCCCCCCCCC)[C@H]1OC(=O)CCCCCCC/C=C\C/C=C\CCCCC]

Procter & Gamble has commercialized a sucrose ester molecule where the hydroxyl groups of sucrose have been esterified by fatty acids of common oils such as soybean and linseed oils. U.S. Pat. No. 6,995,232. The resulting esterified sucrose molecule has a compact structure which results in low viscosity in the absence of solvent. The impetus for this research was manifested by the use of sucrose esters which have low viscosity at 100% solids. In this study, the grafting of styrene and styrene and acrylic acid onto partially esterified sucrose ester resin was explored.

Unexpectedly, it was found that the styrene-grafted sucrose ester resin, an alkyd resin composition of the invention, had a lower viscosity than a commercially produced styrene grafted alkyd resin. Thus, the alkyd resin compositions of the invention can be used to produce coating compostions (paints, etc.) having comparable properties but which require less solvent.

### BRIEF DESCRIPTION OF THE FIGURES

FIG. 1 shows Raman spectra of SPESE resins of the invention.

FIG. 2 shows the dry-times obtained from a BK dry-time recorder for coating compositions of the invention.

FIG. 3 shows the effect of solids content on viscosity of xylene diluted styrenated sucrose ester resin and a commercial styrenated alkyd resin.

### SUMMARY OF THE INVENTION

The invention relates to an alkyd resin composition which comprises the polymerization reaction product of a) an alkyd which is an ester of a polyol having 4 or more hydroxyl groups and an unsaturated fatty acid, and b) an unsaturated monomer having a carbon-carbon double bond. The polymerization of the unsaturated monomer occurs in the presence of the alkyd.

The alkyd resin compositions may be used in a coating composition. Advantageously the coating compositions of the invention require less organic solvent than known compositions.

In a preferred embodiment, the invention relates to monomer-grafting of partially esterified sucrose esters (PESEs) of fatty acids from soybean oil to yield styrenated PESEs (SPESEs) by grafting styrene and styrene and acrylic acid on the fatty acid backbones using t-butoxy radicals as an abstracting initiator. Not all of the unsaturated sites need to be consumed on the fatty acid backbone of the alkyd resin compositions of the invention to allow for and encourage cross-linking by autoxidation using, for example, a cobalt drier after the reaction and upon coating. As described below, the chemical properties of these SPESEs were characterized by gel permeation chromatography (GPC), Raman spectroscopy, and nuclear magnetic resonance (NMR) spectroscopy. The resulting SPESEs have comparable coating properties and viscosity to a commercial styrenated soya based alkyd at a higher solids content. SPESEs were also made to be water-reducible by grafting a copolymer composed of styrene and acrylic acid at acid numbers (AN) 60, 50, and 40. The extent of neutralization (EN) was maintained at 75% for all formulations to facilitate water dispersion. Cross-linking of these coatings was accomplished by reactions with melamine-formaldehyde (MF) resin. Cross-linking using MF resin resulted in cross-linked films with high solvent resistance while maintaining coating flexibility.

### DESCRIPTION OF THE INVENTION

Highly functional resins of the invention are prepared from the graft polymerization of ethylenically unsaturated (vinyl) monomers onto alkyds which are the vegetable oil fatty acid esters of polyols having at least 4 hydroxyl groups/molecule. The polyol esters of fatty acid alkyds containing four or more vegetable oil fatty acid moieties per molecule can be synthesized by the reaction of polyols with 4 or more hydroxyl groups per molecule with either a mixture of fatty acids or esters of fatty acids with a low molecular weight alcohol, as is known in the art. The former method is direct esterification while the latter method is transesterification. A catalyst may be used in the synthesis of these compounds. Sucrose, as an exemplary polyol to be used in the invention, may be esterified with a vegetable oil fatty acid. Vinyl graft polymers may then be introduced by free radical polymerization of vinyl monomers in the presence of the vegetable oil-derived fatty acid(s) to form grafted polyol esters of fatty acid alkyds.

Polyols having at least 4 hydroxyl groups per molecule suitable for the process include, but are not limited to, pentaerithritol, di-trimethylolpropane, di-pentaerithritol, tri-pentaerithitol, sucrose, glucose, mannose, fructose, galactose, raffinose, and the like. Polymeric polyols can also be used including, for example, copolymers of styrene and allyl alcohol, hyperbranched polyols such as polyglycidol and poly(dimethylpropionic acid), and the like. Exemplary polyols are shown below in Scheme 3 with the number of hydroxyl groups indicated by (f). Comparing sucrose to glycerol, there are a number of advantages for the use of a polyol having at least 4 hydroxyl groups/molecule including, but not limited to, a higher number of fatty acids/molecule and a higher number of unsaturations/molecule.

The degree of esterification in the alkyd may be varied. The polyol may be fully esterified, where substantially all of the hydroxyl groups have been esterified with the fatty acid, or it may be partially esterified, where only a fraction of the available hydroxyl groups have been esterified. It is understood in the art that some residual hydroxyl groups may remain even when full esterification is desired. In some applications, as discussed below, residual hydroxyl groups may provide benefits to the resin and to a coating composition containing the resin.

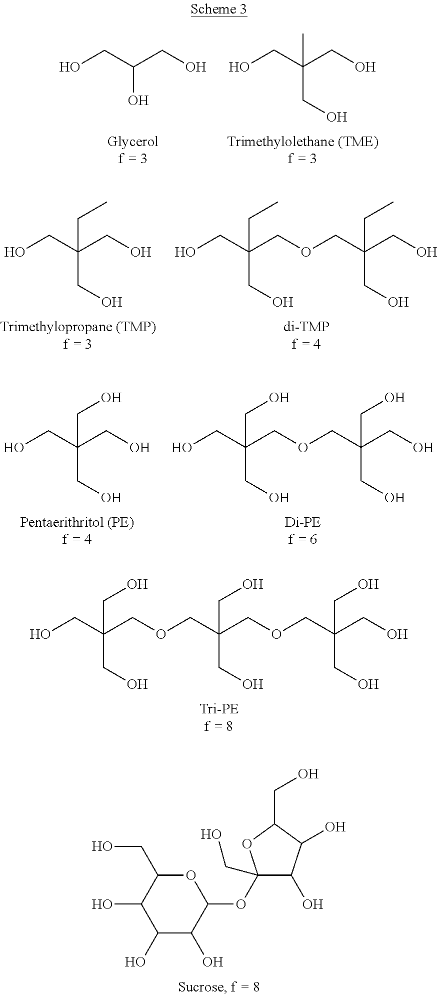

As discussed, for the alkyds used in the invention, the hydroxyl groups on the polyols can be either completely reacted or only partially reacted with fatty acid moieties. Any ethylenically unsaturated fatty acid may be used to prepare a polyol ester of fatty acids to be used in the invention, with polyethylenically unsaturated fatty acids, those with more than one double bond in the fatty acid chain, being preferred. The Omega 3, Omega 6, and Omega 9 fatty acids, where the double bonds are interrupted by methylene groups, and the seed and vegetable oils containing them may be used to prepare polyol ester of fatty acids to be used in the invention. Mixtures of fatty acids and of vegetable or seed oils, plant oils, may be used in the invention. The plant oils, as indicated above, contain mixtures of fatty acids with ethylenically unsaturated and saturated fatty acids possibly present depending on the type of oil. Examples of oils which are sources of the fatty acids which may be used in the invention include, but are not limited to, corn oil, castor oil, soybean oil, safflower oil, sunflower oil, linseed oil, tall oil, tung oil, vernonia oil, and mixtures thereof. In a preferred embodiment, the fatty acid component is those fatty acids derived from soybean oil. As discussed above, the polyol fatty acid ester may be prepared by direct esterification of the polyol or by transesterification as is known in the art. Table 2 lists the double bond functionality of some representative fatty acid esters (=/FA) based upon the number of esterified hydroxyl groups (f).

TABLE 2
Double Bond Functionality of Fatty Acids in Selected Oils

Functionality of = for
FA esters having the
indicated FA functionality

| Oil | Avg. = /FA | f = 3 | f = 4 | f = 6 | f = 8 |
|---|---|---|---|---|---|
| Soybean | 1.54 | 4.62 | 6.16 | 9.24 | 12.32 |
| Safflower | 1.66 | 4.98 | 6.64 | 9.96 | 13.28 |
| Sunflower | 1.39 | 4.17 | 5.56 | 8.34 | 11.12 |
| Linseed | 2.10 | 6.30 | 8.40 | 12.60 | 16.80 |
| Tall Oil | 1.37 | 4.11 | 5.48 | 8.22 | 10.96 |
| Fatty Acid | | | | | |

The polyol ester alkyds used in the invention, and particularly sucrose esters, have compact macromolecular structures, due to the compact structure of the polyol core and the generally uniform distribution of fatty acids around the core. Since the presence of cis double bonds can vary the extension of the fatty acid chains, the amount of double bonds influences the overall dimension of the sucrose ester macromolecules. Therefore, the morphology of sucrose esters is influenced by the morphology of its up to eight fatty acid chains. A dilute solution of polyol ester alkyd molecules, such as sucrose ester molecules, can be thought of as their equivalent spheres. They are uniform, rigid, and non-interacting. For example, the intrinsic viscosity of sucrose esters reflects the hydrodynamic volume of their equivalent spheres.

The free radical grafting of alkyd resins made using unsaturated fatty acids or oils is known to those skilled in the art. The grafting reaction may be accomplished by known methods. See, e.g., Solomon, The Chemistry of Organic Film Formers, 1982, Krieger Publishing, Malabar, Fla., pages 118-124, “Vinyl and Acrylic Modified Oils and Alkyds—Modifications involving the Unsaturation of the Fatty Acid”; and U.S. Pat. Nos. 4,451,596 and 6,844,390. The alkyd resin is grafted with unsaturated monomers containing a carbon-carbon double bond such as styrenic monomers (e.g., styrene, sodium styrene sulfonate, vinyl toluene), acrylic acid and acrylic acid esters (e.g. acrylic acid, methyl acrylate, ethyl acrytlate, butyl acrylate, t-butyl acrylate, hydroxy ethyl acrylate, hydroxy propyl acrylate), methacrylic acid and methacrylic acid esters (e.g. methacrylic acid, methyl methacrylate, ethyl methacrylate, butyl methacrylate, t-butyl methacrylate, hydroxy ethyl methacrylate, hydroxypropyl methacrylate) and the like. This list is representative of unsaturated monomers known in the art and is not exhaustive. See, for example, U.S. Pat. Nos. 4,451,596 and 6,844,390. Preferred are monomers yielding higher Tg polymers such as styrene, vinyl toluene, and methyl methacrylate. The percentage of the unsaturated monomer to the alkyd resin can be in the range of 20 to 80 weight percent, preferably 40 to 60 weight percent.

The grafting reaction involves the free radical polymerization of the unsaturated monomer(s) in the presence of the alkyd resin. A free radical initiator is used to initiate the polymerization. The free radical initiator can be any commonly used thermal free radical initiator including the classes of azo initiators, hydroperoxides, diaryl peroxides, dialkyl peroxides, peroxy esters, and the like. Generally preferred are the peroxide initiators since peroxy radicals are known to be effective at abstracting hydrogen radicals. Such grafting reactions are known in the art, for example, as described in U.S. Pat. Nos. 2,468,748; 2,521,675; 2,650,907; 2,928,796; and 6,844,390.

Grafting of the unsaturated monomer onto the alkyd resin is believed to occur primarily via a radical-abstraction mechanism. A free radical in the system, generally from the initiator, abstracts a hydrogen radical from the fatty acid group in the alkyd resin, generating a free radical which can initiate the polymerization of the unsaturated monomer.

Grafting can also occur through radical-radical combination of a propagating polymer chain of the unsaturated monomer with a radical formed on the fatty acid of the alkyd. In addition, it is also possible that the free radical polymerization could proceed through the unsaturated vinyl group present on the fatty acid moiety of the alkyd resin.

The final product of the grafting reaction may contain alkyd resin which has not been grafted with the unsaturated monomer, homopolymer of the unsaturated monomer (copolymer if more than one monomer is used), and some amount of alkyd resin with the unsaturated monomer grafted onto it.

As is known in the art, a typical method for the graft polymerization involves charging the alkyd resin and solvent to a flask, heating the mixture to the desired reaction temperature, separately mixing the free radical initiator with the monomer, then adding the monomer-initiator slowly to the solution of alkyd resin.

A grafted resin which is also water-dispersible or water-reduceable can also be synthesized using similar methods and represents an embodiment of the invention. An unsaturated monomer having ionized or ionizable groups is used either alone or in combination with another vinyl monomer in the grafting reaction. Such monomers can include acrylic acid, methacrylic acid, sodium styrene sulfonate, and the like. A water miscible organic solvent is also used in the grafting reaction. Examples of water miscible organic solvents include, but are not limited to, N-methyl pyrollidone, propylene glycol monomethyl ether and ethylene glycol butyl ether. For example, an alkyd resin composition of the invention made be water-reducible by grafting a copolymer composed of such unsaturated monomers, for example a styrene and acrylic acid copolymer, having a sufficient acid number (AN) to provide water reduceability or dispersibility. For example, the copolymer may have an AN of 60, 50, or 40.

After the grafting reaction, ionizable groups are neutralized to form ionic groups. For carboxylic acid groups, this would be accomplished by the addition of a base. Examples of bases include sodium hydroxide, potassium hydroxide, ammonia, triethyl amine, morpholine, and the like. Preferred are those bases which are volatile, such as ammonia and triethyl amine. Following neutralization, water is added to the resin to form a dispersion. The extent of neutralization (EN) should facilitate water dispersion and is generally maintained at about 75% for coating compositions of the invention.

The invention also relates to the use of an alkyd resin composition of the invention in a coating or paint composition which may be coated onto a substrate and cured using techniques known in the art. Alkyd coating compositions are well known in the art. An alkyd resin composition of the invention may be used in the same way as known alkyd resins to form a coating composition. A typical alkyd coating composition may have the following formulation using components known in the art, although the amounts of each component may vary.

Example of a typical composition of an alkyd paint mixture

| Component | Weight % |
|---|---|
| Alkyd Binder | 30 |
| Organic solvent | 27 |
| Water | 10 |
| Pigments | 19 |
| Extenders | 12 |
| Additives | 2 |

See, van Gorkum,R,. Bouwman, E./ Coordination Chemistry Reviews 249 (2005) 1709-1728 and U.S. Pat. No. 6,844,390.

The substrate can be any common substrate such as paper, polyester films such as polyethylene and polypropylene, metals such as aluminum and steel, glass, urethane elastomers, primed (painted) substrates, and the like. The coating composition of the invention may be allowed to air dry to form a solid film or it may be cured thermally using a crosslinker reactive with reactive functional groups present in the resin.

To further catalyze the autoxidation curing of the resins, catalysts known as “driers” in the art can be employed. See, e.g., van Gorkum, R., Bouwman, E., “The oxidative drying of alkyd paint catalysed by metal complexes.” Coordination Chemistry Reviews, 249 1709-1728 (2005). Driers are typically organometallic compounds of transition metals. Driers can be further classified as primary secondary or auxiliary driers. Primary driers are salts of metals such as cobalt, manganese, iron, cerium, or vanadium. Secondary driers are based on lead, zirconium, bismuth, barium, aluminum, and strontium. Auxiliary driers are compounds of calcium, zinc, lithium, potassium. Mixtures of driers can be used to optimize the curing characteristics of the coatings.

Those resins of the present invention which have hydroxyl or carboxylic acid groups may also be thermally cured using amino resins (also known in the art as aminoplast resins). Amino resins are well known to those skilled in the art as curing agents and include urea-formaldehyde and melamine-formaldehyde resins among others. See, e.g., Wicks, Jones, Pappas, Wicks, Organic Coatings: Science and Technology, 3^{rd} edition, Wiley Interscience, 2007, chapter 11. Melamine-formaldehyde resins are preferred. The amino resin is mixed with the monomer modified resin along with a catalyst. The amino resin content can range from 5 weight percent to 65 weight percent of the formulation, preferably between 10 and 40 weight percent. The curing is catalyzed using acid catalysts such as para-toluene sulfonic acid, dodecylbenzene sulfonic acid, naphthalene sulfonic acid, and the like. Blocked catalysts may also be used to improve the package stability. The catalyst can be used in an amount from 0.1 weight percent to 10 weight percent of the binder composition (resin plus crosslinker), preferably from 0.2 percent to 5 weight percent.

The coatings of the invention are cured by baking at temperatures ranging from 120° C. to 220° C., preferably 140° C. to 180° C.

As indicated in the typical alkyd paint composition above, pigments and other coating additives known in the art to control coating and surface properties can also be incorporated into a coating composition of the invention. For example a coating composition of the invention may further contain coating additives. Such coating additives include, but are not limited to, one or more leveling, rheology, and flow control agents such as silicones, fluorocarbons or cellulosics; extenders; reactive coalescing aids such as those described in U.S. Pat. No. 5,349,026, incorporated herein by reference; plasticizers; flatting agents; pigment wetting and dispersing agents and surfactants; ultraviolet (UV) absorbers; UV light stabilizers; tinting pigments; colorants; defoaming and antifoaming agents; anti-settling, anti-sag and bodying agents; anti-skinning agents; anti-flooding and anti-floating agents; biocides, fungicides and mildewcides; corrosion inhibitors; thickening agents; or coalescing agents. Specific examples of such additives can be found in Raw Materials Index, published by the National Paint & Coatings Association, 1500 Rhode Island Avenue, N.W., Washington, D.C. 20005. Further examples of such additives may be found in U.S. Pat. Nos. 5,371,148 and 6,844,390, incorporated herein by reference. Each of these may be used in the amounts known in the art for alkyd coating compositions.

Solvents may also be added to the coating formulation in order to reduce the viscosity. Hydrocarbon, ester, ketone, ether, ether-ester, alcohol, or ether-alcohol type solvents may be used individually or in mixtures. Examples of solvents can include, but are not limited to benzene, toluene, xylene, aromatic 100, aromatic 150, acetone, methylethyl ketone, methyl amyl ketone, butyl acetate, t-butyl acetate, tetrahydrofuran, diethyl ether, ethylethoxy propionate, isopropanol, butanol, butoxyethanol, and so on.

The patents and references discussed are incorporated herein by reference and in their entirety.

### EXAMPLES

Materials

Di-tert-butyl peroxide (Luperox DI, 98%), styrene 99%), acrylic acid (99%), xylenes (98.5+%), p-toluenesulfonic acid monohydrate 98.5%), and dimethylaminoethanol (DMAE) were obtained from Sigma-Aldrich. Procter & Gamble provided partially esterified sucrose soyate (SEFOSE 1618U B6). Cobalt HEX-CEM (12%) was obtained from OMG (OH). 2-Butoxyethanol (EB solvent) was obtained from Eastman Chemical Company. Resimene 755 was obtained from Surface Specialties Inc. Nuplex provided Setyrene 13-1405 (styrenated soya based alkyd), which was used as a control.

Synthesis

Synthesis of Styrenated Partially Esterified Sucrose Soyate (SPESE)

As shown in Scheme 1 below, with a positive nitrogen pressure, a feed consisting of styrene and di-tert-butyl peroxide (8% wt. styrene) was added dropwise at a rate of 24 mL hr⁻¹ to a solution of sucrose ester in xylenes at 149.1° C. In Scheme 1, “n” and “m” indicate the polymeric nature of the grafted monomers. After the addition was complete, the temperature was maintained until ca. 94% of the initiator decomposed, as determined by the theoretical decomposition rate. Sucrose ester:styrene weight ratios of 50:50, 60:40, 70:30, and 80:20 were synthesized.

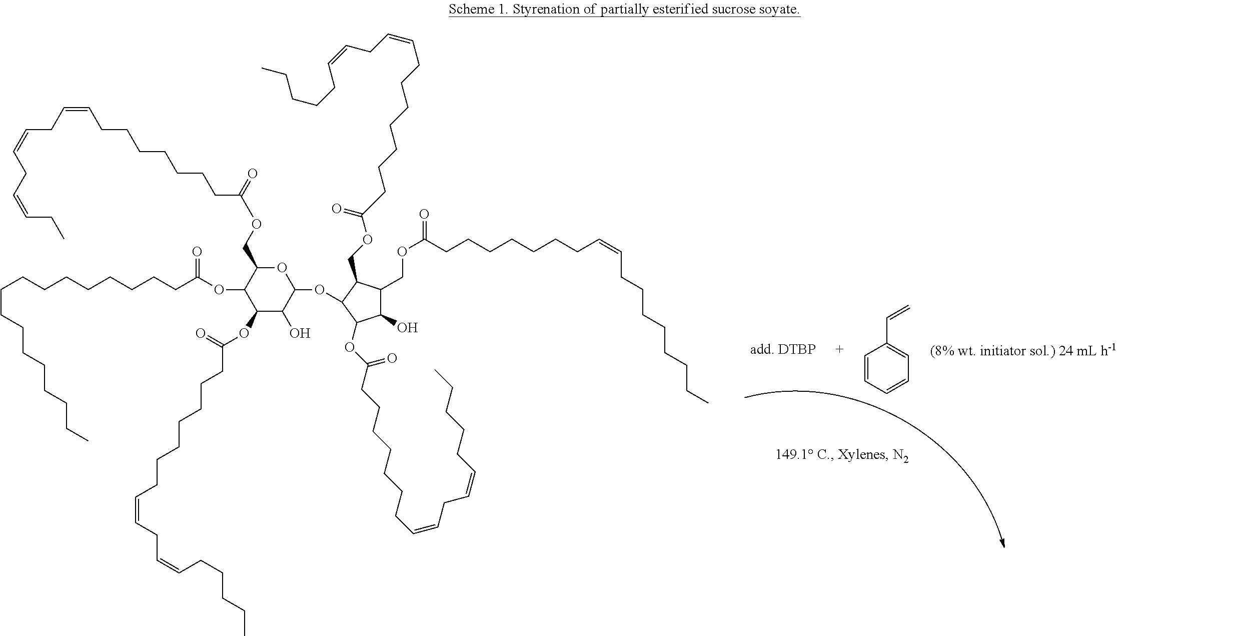

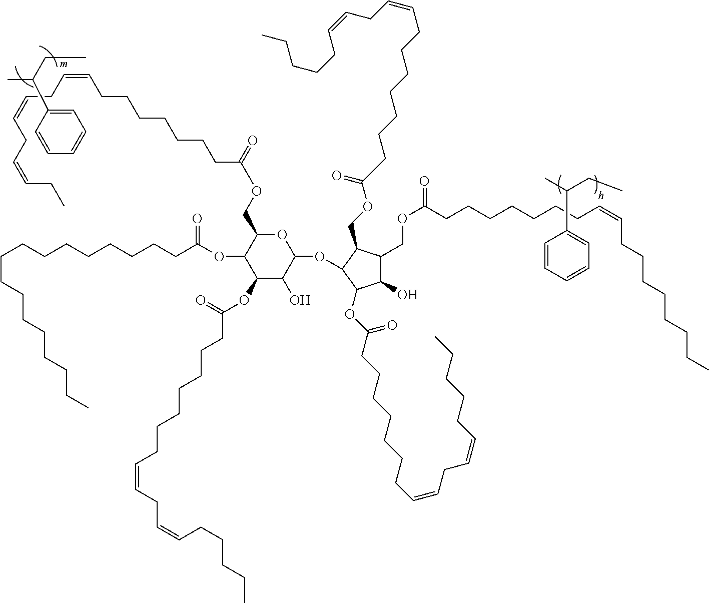

Synthesis of Water-Reducible Partially Esterified Sucrose Soyate (WRPESE)

As shown in Scheme 2 below, partially esterified sucrose esters were made water-reducible by conducting a styrenation reaction with a monomer feed consisting of styrene, acrylic acid, and di-tert-butyl peroxide (8% wt. styrene) in EB solvent. The polymeric nature of the grafted monomers is indicated by the parentheses around them. A 50:50 wt. (sucrose ester:styrene) ratio was maintained for all the water-reducible reactions and the acid number (AN) was altered by the amount of acrylic acid in the monomer feed. Water-reducible resins having acid numbers of 40, 50, and 60 were synthesized.

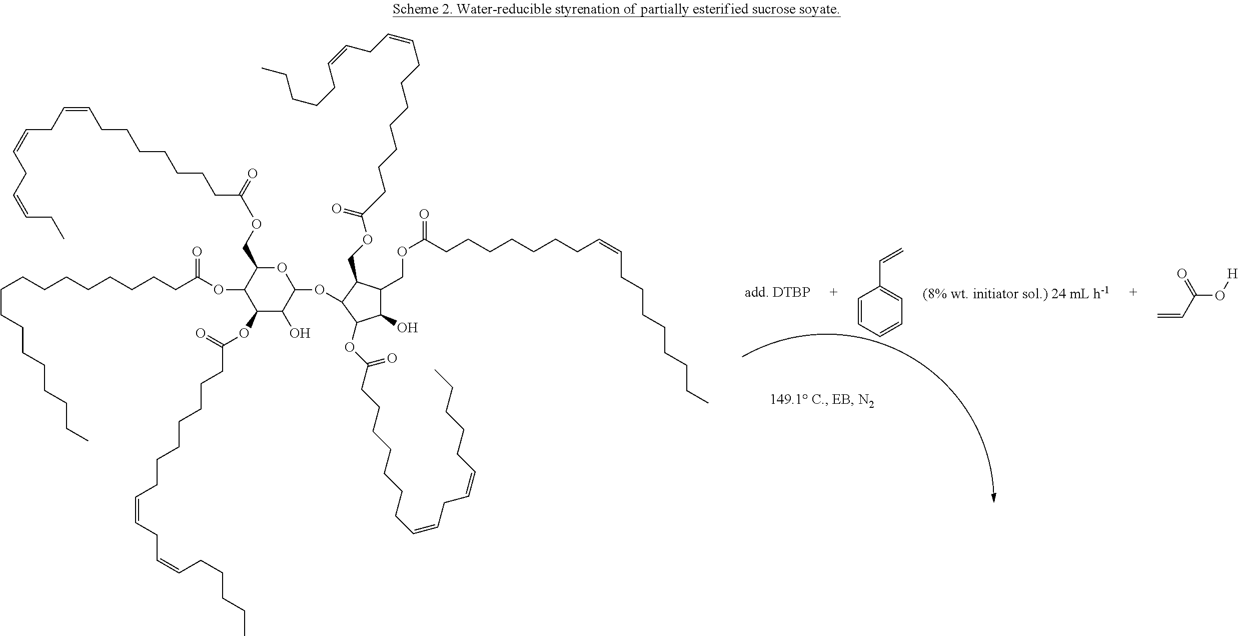

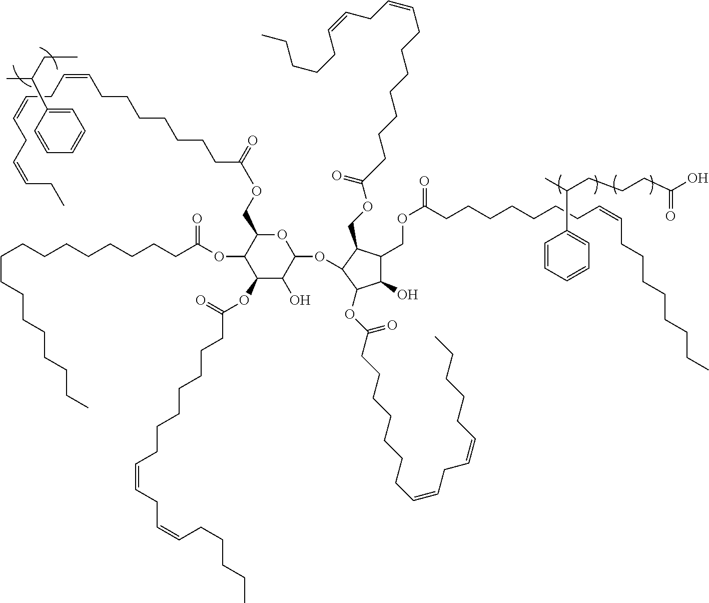

Coating Formulation

SPESE resins were cast on cleaned steel panels (QD-36, Q Panel) using a draw-down bar at 5 mil wet film thickness. Resins 50:50 and 60:40 needed additional dilution with xylenes in order to obtain sufficient application viscosity. Cobalt drier was also added to SPESE in order to form films by autoxidation. WRPESE resins were neutralized with dimethylaminoethanol to an extent of neutralization of 75% followed by a slow addition of deionized water until a suitable application viscosity was reached. The diluted resins were hand-mixed with melamine-formaldehyde (MF) resin (25% wt. based on solids) and pTSA (0.5% wt. solids) which was diluted in isopropanol. WRPESEs were cast on cleaned steel panels using a draw-down bar at 8 mils wet film thickness. All coatings formulated with cobalt drier were allowed to air-dry for 7 days. Coatings cross-linked with MF resin were baked at 150° C. for 40 min. Setyrene 13-1405 was allowed to air-dry for 7 days without cobalt catalyst.

Drying-Time Determination

The drying times were determined using a B.K. Drying Recorder. Three drying phases were determined: phase 1 corresponds to the open-time, phase 2 corresponds to the dust-free time, and phase 3 corresponds to the tack-free time.

Characterization

Raman Measurement

Liquid resin samples were placed in a well plate and stored in a vacuum oven set at 60° C. for 8 hours to remove any solvent present. Raman spectroscopy was performed using a Nicolet NXR 9650 FT-Raman Spectrometer equipped with a liquid nitrogen-cooled germanium detector. The excitation laser had a wavelength of 1064 nm and the laser power was set at 0.7 W and adjusted as needed in order to improve signal strength. The data was processed and analyzed using OMNIC software.

Coating Properties

Mechanical Coating Properties

The coating performance was tested based on ASTM methods listed in Table 3.

TABLE 3
Mechanical Coating properties characterization

| Specification | ASTM Methods |
|---|---|
| König Pendulum Hardness | ASTM D 4366-95 |
| Reverse Impact | ASTM D 3363-00 |
| Conical Mandrel | ASTM D 3359-97 |
| MEK Double Rub Resistance | ASTM D 5402-93 |

Results and Discussion

Synthesis of SPESE Resins

Raman

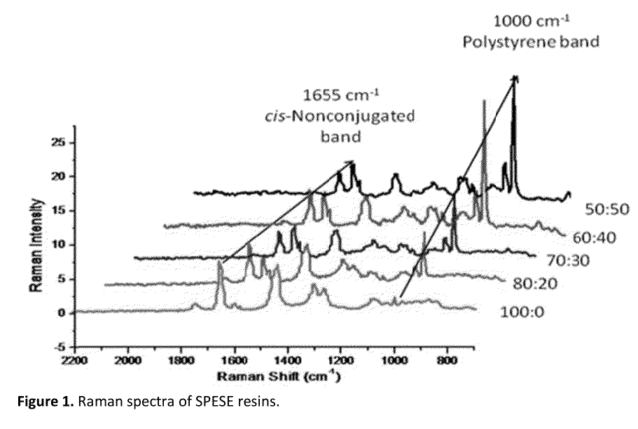

Evidence for grafting of polystyrene on the fatty acid backbone was provided by Raman spectroscopy (FIG. 1). The area of the polystyrene band at 1000 cm⁻¹ was compared to the area of the cis nonconjugated double bond band at 1655 cm⁻¹. The increase in Δ(Area_{1000 cm}⁻¹/Area_{1655 cm}⁻¹) in Table 4 for the 50:50 resin is indicative of the cis nonconjugated double bonds being depleted during the styrenation reaction. FIG. 1 also indicates the presence of residual cis nonconjugated double bonds for all the SPESEs which can be available for autoxidation.

TABLE 4
Integration of Raman Peaks for SPESE Resins

| Resin | Area_{1000 cm}⁻¹/Area_{1655 cm}⁻¹ | Δ(Area_{1000 cm}⁻¹/Area_{1655 cm}⁻¹) |
|---|---|---|
| 100:0 | 0.09 | — |
| 80:20 | 0.80 | 0.71 |
| 70:30 | 1.71 | 0.92 |
| 60:40 | 2.24 | 0.52 |
| 50:50 | 4.02 | 1.78 |

Drying Times

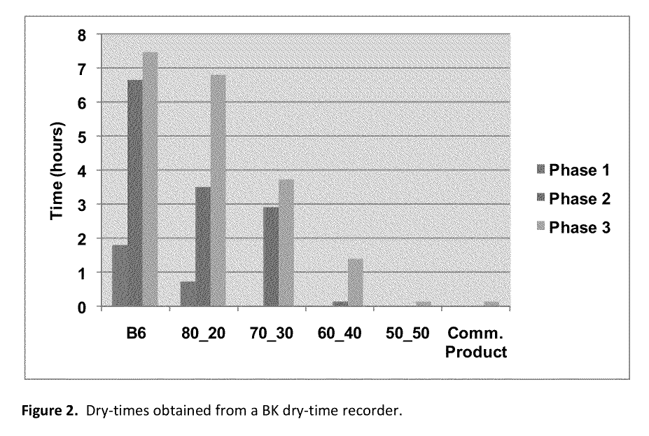

The drying times determined by the drying recorder of SPESE with cobalt drier decreased as the amount of styrene increased as shown in FIG. 2. Polystyrene, with its higher T_{g}, hardens the coating resulting in decreased dry-times. The dry-times of SPESE were also compared to a commercial styrenated soya based alkyd. The tack-free time of the commercial product and the 50:50 resin were comparable (ca. 10 min.).

Coating Properties of SPESE and WRPESE

Mechanical Coating Properties

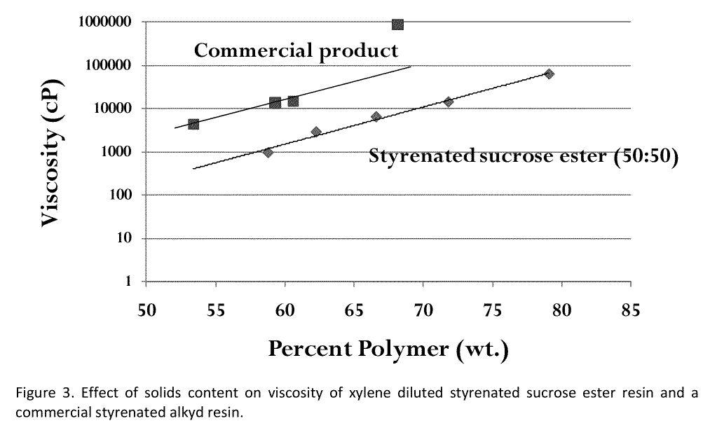

Table 5 shows a large increase in Konig pendulum hardness as the styrene content is increased. However, less cross-linking is observed in SPESEs compared to the sucrose ester which is attributed to the consumption of some of the autoxidation sites and poorer oxygen diffusivity in the harder films. SPESE 50:50 and the commercial styrenated product have similar coatings properties in terms of hardness and flexibility. However, SPESE 50:50 has less VOC as determined by viscosity versus dilution curve (FIG. 3) and extrapolating to 100 mPa s, which is attributed to the use of the solvent-less sucrose ester material instead of a solvent-borne alkyd during the styrenation reaction. The VOC calculated by this method for SPESE 50:50 was 483 g/L versus 609 g/L for the commercial product.

TABLE 5
Coatings Properties of SPESE with Drier

| | König | Reverse | Conical Mandrel | MEK |
|---|---|---|---|---|
| | Pendulum | Impact | (% Elongation- | Double Rub |
| Sample | Hardness (s) | (in Lbs) | at-Break) | Resistance |
| 100:0 | 12 ± 1 | >172 | >28% | 70 |
| 80:20 | 18 ± 0 | 148 | >28% | 21 |
| 70:30 | 39 ± 1 | 12 | >28% | 27 |
| 60:40 | 72 ± 1 | 4 | >28% | 20 |
| 50:50 | 123 ± 2 | 4 | <3% | 21 |
| Commercial | 133 ± 2 | 4 | <3% | 14 |
| Product | | | | |

WRPESE have more cross-linking options as a result of the acid groups. The high solvent resistance of MF cured WRPESE was attributed to a higher cross-link density compared to the SPESE cured by autoxidation. Table 6 shows that the elongation-at-break remained high indicating sufficient flexibility in the polymeric network during a slow deformation.

TABLE 6
Coatings Properties of WRPESE with MF Resin

| | König | Reverse | | MEK |
|---|---|---|---|---|
| | Pendulum | Impact | Conical Mandrel (% | Double Rub |
| Sample | Hardness (s) | (in Lbs) | Elongation-at-Break) | Resistance |
| AN = 40 | 100 ± 2 | 84 | >28% | >400 |
| AN = 50 | 102 ± 9 | 90 | >28% | >400 |
| AN = 60 | 154 ± 1 | 40 | >28% | >400 |

Monomer-grafted alkyd resins of the invention, partially esterified sucrose soyate resins were successfully prepared. Raman spectroscopy gives evidence for a reduction in cis nonconjugated double bonds relative to the polystyrene concentration which indicates reactions are taking place on or near the cis double bond. The coatings properties of SPESE 50:50 such as drying time, hardness, and flexibility resembled the properties of the commercialized styrenated soya based alkyd. Water-reducible copolymers cross-linked with MF resin provide higher solvent resistance, which was attributed to a higher cross-link density than SPESEs.

1. An alkyd resin composition comprising the polymerization reaction product of:
a) an alkyd which is an ester of a polyol having 4 or more hydroxyl groups and an unsaturated fatty acid, and
b) an unsaturated monomer having a carbon-carbon double bond,
wherein the polymerization of the unsaturated monomer occurs in the presence of the alkyd.

2. An alkyd resin composition of claim 1, wherein:
the polyol having 4 or more hydroxyl groups is selected from pentaerithritol, di-trimethylolpropane, di-pentaerithritol, tri-pentaerithitol, sucrose, glucose, mannose, fructose, galactose, raffinose, copolymers of styrene and allyl alcohol, polyglycidol and poly(dimethylpropionic acid);
the unsaturated fatty acid is from a vegetable or seed oil or mixtures thereof; and
the unsaturated monomer is a styrenic momoner, acrylic acid or an acrylic acid ester, methacrylic acid or a methacrylic acid ester or mixtures thereof.

3. An alkyd resin composition of claim 2, wherein:
the polyol having 4 or more hydroxyl groups is sucrose;
the vegetable or seed oil is selected from corn oil, castor oil, soybean oil, safflower oil, sunflower oil, linseed oil, tall oil, tung oil, vernonia oil, and mixtures thereof; and
the unsaturated monomer is styrene, vinyl toluene, sodium styrene sulfonate, acrylic acid, methacrylic acid, methyl methacrylate or mixtures thereof.

4. An alkyd resin composition of claim 1 wherein the hydroxyl groups on the polyol are substantially esterified by the fatty acids.

5. An alkyd resin composition of claim 1 wherein a fraction of the hydroxyl groups on the polyol are esterified by the fatty acids.

6. An alkyd resin composition of claim 1, wherein:
the polyol having 4 or more hydroxyl groups is sucrose, and
the unsaturated fatty acid, or mixtures thereof is soybean oil.

7. An alkyd resin composition of claim 6, having an alkyd:unsaturated monomer ratio of 50:50, 60:40, 70:30, or 80:20 weight percent.

8. An alkyd resin composition of claim 7, wherein the alkyd resin composition is water dispersible.

9. An alkyd resin composition of claim 8, wherein the alkyd resin composition has an acid number of 40, 50, or 60.

10. A coating composition comprising an alkyd resin composition of claim 6, a pigment, an optional organic solvent, optional water, an optional extender, an optional additive, and an optional drier.

11. An alkyd resin composition of claim 1, having an alkyd:unsaturated monomer ratio of 50:50, 60:40, 70:30, or 80:20 weight percent.

12. An alkyd resin composition of claim 11, wherein the alkyd resin composition is water dispersible.

13. An alkyd resin composition of claim 12, wherein the alkyd resin composition has an acid number of 40, 50, or 60.

14. An alkyd resin composition of claim 6, having an alkyd:unsaturated monomer ratio of 50:50 weight percent.

15. A coating composition comprising an alkyd resin composition of claim 11, a pigment, an optional organic solvent, optional water, an optional extender, an optional additive, and an optional drier.

16. An object coated with a coating composition of claim 15.

17. A method of making an alkyd resin composition of claim 6, comprising the step of:
polymerizing the unsaturated monomer in the presence of the alkyd.

18. A method of claim 17, having an alkyd ester:unsaturated monomer ratio of 50:50, 60:40, 70:30, or 80:20 weight percent.
